(19) United States
(12) Patent Application Publication
(10) Pub. No.: US 2019/0297144 A1
(43) Pub. Date: Sep. 26, 2019

(54) METHOD AND SYSTEM FOR IMPROVED DISTRIBUTED DATA STORAGE AMONGST MULTIPLE COMPUTING NODES

(71) Applicant: Wipro Limited, Bangalore (IN)

(72) Inventor: Chaitanya Rajendra Zanpure, Pune (IN)

(21) Appl. No.: 15/940,060

(22) Filed: Mar. 29, 2018

(30) Foreign Application Priority Data
Mar. 21, 2018 (IN) 201841010384

(51) Int. Cl. H04L 29/08; G06F 11/20

(52) U.S. Cl. CPC H04L 67/1097; G06F 2201/85; G06F 11/2094; G06F 11/2023

(57) ABSTRACT

A method and device for improved distributed data storage amongst multiple computing nodes is disclosed. The method includes generating, by an application server, a plurality of node Identifiers (IDs) comprising a pseudo random sequence of at least one of the plurality of computing nodes, wherein the plurality of node IDs is associated with the plurality of computing nodes. The method further includes selecting, by the application server, a node ID from the plurality of node IDs for data placement of a computing node, based on a placement score computed for each of the plurality of node IDs, wherein the node ID comprises a highest placement score amongst the plurality of node IDs. The method includes reassessing, by the application server, the data placement after a predefined time interval, wherein reassessing comprises determining whether the node ID comprises the highest placement score after expiry of the predefined time interval.

This application claims the benefit of Indian Patent Application Serial No. 201841010384 filed Mar. 21, 2018, which is hereby incorporated by reference in its entirety.

### FIELD

This disclosure relates generally to distributed data storage and more particularly to method and device for improved distributed data storage amongst multiple computing nodes.

### BACKGROUND

In a highly distributed data storage system, data is necessarily spread over several physically separate computer storage servers (nodes). This is necessary, as each node has a limited physical storage capacity, and the total storage capacity of the system is designed to be much greater than that of a single node, which may ideally approach the sum of the storage of all individual computing nodes.

With many physical servers, there is a relative increase in the possibility of failure (temporary or permanent), compared to a single node alone. If a node storing some fraction of the data becomes unavailable for any reason, the system should be able to provide the data from an alternative (or backup) node. In such cases, clients wishing to access data need to know the nodes that have copies of the data, so that multiple alternatives to access data may be tried.

Conventional systems focus on two basic mechanisms that enable clients to find out location of backup data. The first mechanism is to ask a known authority node and the second is to directly work out location of the backup data from the data reference/address in the primary node. The first mechanism is not fault-tolerant, because if the central node fails, all data would be left inaccessible.

The second mechanism is preferred in large horizontally scalable systems. One of conventional methods that implement the second mechanism is consistent hashing, which is a way to locate data amongst a number of distributed nodes in a predictable way. This enables clients to know exactly which nodes should be contacted, without needing to refer to any central authority node.

Some conventional systems that use consistent hashing view the numeric data reference address as a number that describes a position on a circle. A reference may typically range from 0 to a large integer (often 2n), and a node ID is labelled on multiple positions around this circle. To find data, the client starts at the position pointed to by the data reference and moves clockwise around the circle of potential positions until a valid (non-null) node ID is found. This node, and nodes further around in the same direction, are the nodes that include the data sought. However, optimal placement schemes followed by these conventional systems first calculate the initial position of the data in the circular hashing space. In other words, the starting position is located on this circle of potential node IDs. Second, incremental counting around the circle is started from this position to find required IDs of nodes that may store the copies of the data. Thus, for reading data, only the first responding node is required.

These conventional systems suffer from potentially sub-optimal placements, as nodes are fundamentally located in a fixed order, once the starting position on the “hash circle” has been determined. In other words, once the starting position is found, the series of nodes that store the redundant copies is identical. This is vulnerable to the problem of cascading failure, where the failure of first node causes all clients to pass their requests onto the second node in sequence, which can result in increasing the load on the second node, thereby causing its failure. This effect then continues to the third node in an amplified way. Thus, a single node failure causes uneven distribution of load to other nodes, which may increase the chance of a total system failure.

### SUMMARY

In one embodiment, a method of distributed data storage amongst a plurality of computing nodes is disclosed. The method includes generating, by an application server, a plurality of node Identifiers (IDs) comprising a pseudo random sequence of at least one of the plurality of computing nodes, wherein the plurality of node IDs is associated with the plurality of computing nodes. The method further includes selecting, by the application server, a node ID from the plurality of node IDs for data placement of a computing node, based on a placement score computed for each of the plurality of node IDs, wherein the node ID comprises a highest placement score amongst the plurality of node IDs. The method includes reassessing, by the application server, the data placement after a predefined time interval, wherein reassessing comprises determining whether the node ID comprises the highest placement score after expiry of the predefined time interval.

In another embodiment, a method of distributed data storage with a failover mechanism is disclosed. The method includes generating, by an application server, a plurality of node IDs comprising a pseudo random sequence of at least one of a plurality of computing nodes, wherein the plurality of node IDs is associated with the plurality of computing nodes. The method further includes selecting, by the application server, a node ID from the plurality of node IDs for data placement of a computing node, based on a placement score computed for each of the plurality of node IDs, wherein the node ID comprises a highest placement score amongst the plurality of node IDs. The method includes identifying, by the application server, a failover node from a set of computing nodes associated with the node ID, based on a failover score computed for each of the set of computing nodes.

In yet another embodiment, an application server enabling distributed data storage amongst a plurality of computing nodes is disclosed. The application server includes a processor and a memory communicatively coupled to the processor, wherein the memory stores processor instructions, which, on execution, causes the processor to generate a plurality of node IDs comprising a pseudo random sequence of at least one of the plurality of computing nodes, wherein the plurality of node IDs is associated with the plurality of computing nodes. The processor instructions further cause the processor to select a node ID from the plurality of node IDs for data placement of a computing node, based on a placement score computed for each of the plurality of node IDs, wherein the node ID comprises a highest placement score amongst the plurality of node IDs. The processor instructions cause the processor to reassess the data placement after a predefined time interval, wherein reassessing comprises determining whether the node ID comprises the highest placement score after expiry of the predefined time interval.

In another embodiment, an application server enabling distributed data storage with a failover mechanism is disclosed. The application server includes a processor and a memory communicatively coupled to the processor, wherein the memory stores processor instructions, which, on execution, causes the processor to generate a plurality of node IDs comprising a pseudo random sequence of at least one of a plurality of computing nodes, wherein the plurality of node IDs is associated with the plurality of computing nodes. The processor instructions further cause the processor to select a node ID from the plurality of node IDs for data placement of a computing node, based on a placement score computed for each of the plurality of node IDs, wherein the node ID comprises a highest placement score amongst the plurality of node IDs. The processor instructions cause the processor to identify a failover node from a set of computing nodes associated with the node ID, based on a failover score computed for each of the set of computing nodes.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 is a block diagram illustrating a system for distributed data storage, in accordance with an embodiment.

FIG. 2 is a block diagram illustrating various modules within a memory of an application server that enables distributed data storage amongst a plurality of computing nodes, in accordance with an embodiment.

FIG. 3 illustrates a flowchart of a method of distributed data storage amongst a plurality of computing nodes, in accordance with an embodiment.

FIG. 4 illustrates a flowchart of a method of selection of a node ID for data placement and reassessment of the selection, in accordance with an embodiment.

FIG. 5 illustrates flowchart of a method of distributed data storage with a failover mechanism, in accordance with an embodiment.

FIG. 6 illustrates flowchart of a method of selecting a failover node for distributed data storage, in accordance with an embodiment.

FIG. 7 illustrates a block diagram of an exemplary computer system for implementing various embodiments.

### DETAILED DESCRIPTION

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims.

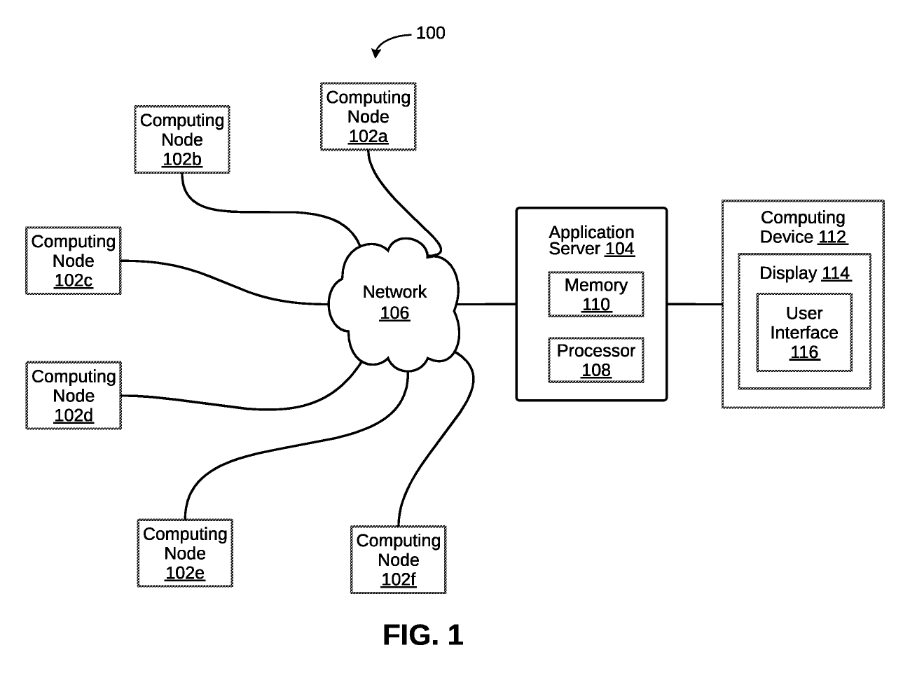

Additional illustrative embodiments are listed below. In one embodiment, a block diagram illustrating a system 100 for distributed data storage is illustrated in FIG. 1. System 100 includes a plurality of computing nodes 102 (depicted in FIG. 1 by computing nodes 102a to 102f), which may include virtual computing nodes and physical computing nodes. It will be apparent to a person skilled in the art that the invention is not limited to the number of nodes depicted in FIG. 1 and may include more than 64000 computing nodes. Examples of plurality of computing nodes 102 may include, but are not limited to a storage server, an application server, a desktop, or a laptop. Plurality of computing nodes 102 may be used for distributed data storage, such that, for a given data or application, two or more computing nodes from plurality of computing nodes 102 may be used to store copies or instances of the data or application. As a result, if one of the two or more nodes fail, the remaining nodes may be used to access data or application.

Distributed data storage on plurality of computing nodes 102 is enabled by an application server 104, which is communicatively coupled to each of plurality of computing nodes 102, via a network 106. Network 106 may be a wired or a wireless network and the examples may include, but are not limited to the Internet, Wireless Local Area Network (WLAN), Wi-Fi, Long Term Evolution (LTE), Worldwide Interoperability for Microwave Access (WiMAX), and General Packet Radio Service (GPRS).

In order to provide distributed data storage on plurality of computing nodes 102, application server 104 includes a processor 108 that is communicatively coupled to a memory 110, which may be a non-volatile memory or a volatile memory. Examples of non-volatile memory, may include, but are not limited to a flash memory, a Read Only Memory (ROM), a Programmable ROM (PROM), Erasable PROM (EPROM), and Electrically EPROM (EEPROM) memory. Examples of volatile memory may include, but are not limited Dynamic Random Access Memory (DRAM), and Static Random-Access memory (SRAM).

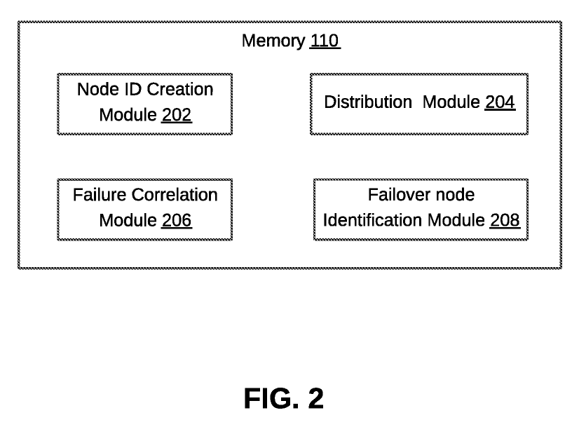

Memory 110 further includes various modules that enable distributed data storage by application server 104. These modules are explained in detail in conjunction with FIG. 2. Application server 104 may further be coupled to a computing device 112 that may include a display 114 having a User Interface (UI) 116. UI 116 may be used by a user or an administrator to provide various inputs to application server 104. Display 114 may further be used to display details associated with distributed data storage on plurality of computing nodes 102. Examples of computing device 112 may include, but are not limited to a laptop, a desktop, a smart phone, or a tablet.

Referring now to FIG. 2, a block diagram of various modules within memory 110 of application server 104 that enables distributed data storage amongst plurality of computing nodes 102 is illustrated, in accordance with an embodiment. Memory 110 includes a node Identifier (ID) creation module 202, a distribution module 204, a failure correlation module 206, and a failover node identification module 208.

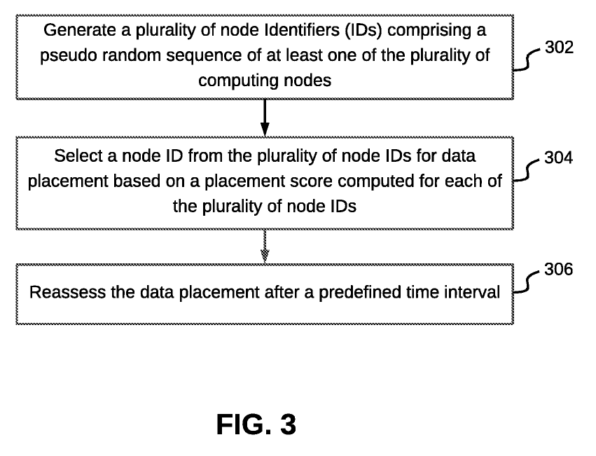

Node ID creation module 202 generates a plurality of node IDs associated with plurality of computing nodes 102. Each of the plurality of node IDs include a pseudo random sequence of one or more of plurality of computing nodes 102. This is further explained in detail in conjunction with FIG. 3. Distribution module 204 selects a node ID from the plurality of node IDs for data placement of a computing node, based on a placement score computed for each of the plurality of node IDs. The node ID that has a highest placement score amongst the plurality of node IDs. This ensures that, when a primary node fails, the impact of the load of primary node is spread evenly amongst the remaining plurality of computing nodes 102 and subsequent failures are also spread out evenly.

Failure correlation module 206 determines the predefined scoring criteria, which may include location of adjacent computing nodes within the node ID. Additionally, the predefined scoring criterion for a node ID may include failure probability of each computing node within the node ID. A computing node's failure probability may be expressed as a failure correlation matrix, which may describe likelihood of individual and pairwise failure of computing nodes. This is further explained in detail in conjunction with FIG. 3.

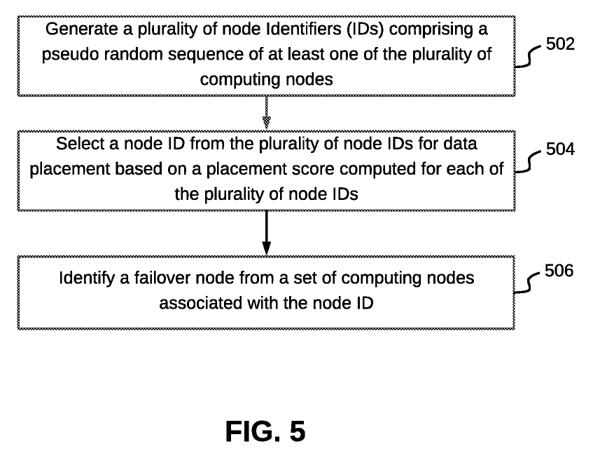

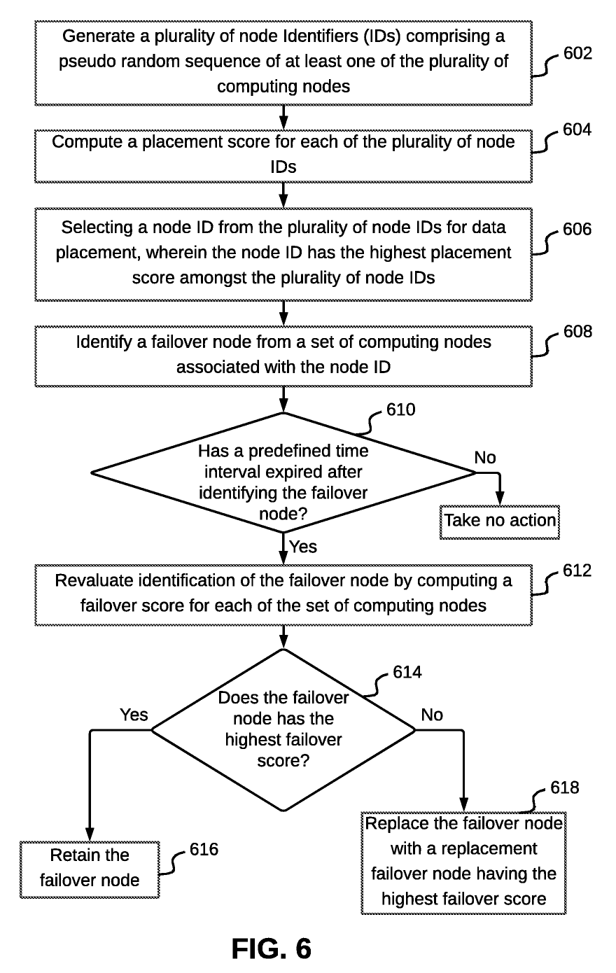

Failover node identification module 208 identifies a failover node from a set of computing nodes associated with the node ID, based on a failover score computed for each of the set of computing nodes. This is further explained in detail in conjunction with FIG. 5 and FIG. 6.

Referring now to FIG. 3, a flowchart of a method of distributed data storage amongst plurality of computing nodes 102 is illustrated, in accordance with an embodiment. At step 302, application server 104 generates a plurality of node Identifiers (IDs) associated with plurality of computing nodes 102. Each of the plurality of node IDs include a pseudo random sequence of one or more of plurality of computing nodes 102. In an embodiment, a node ID may be generated using equation 1 given below:

Node_ID=FUNCTION (data_reference)[counter] (1)

In the above equation, the FUNCTION generates a pseudo random sequence by applying a pseudo random permutation function. Thus, the pseudo random sequence for each of the plurality of node IDs is unique. Using random permutation functions to set the sequence of computing nodes, ensures that each node ID has a completely separate (pseudo random) sequence of computing nodes onto which their redundant data is stored. When one computing node for a node ID fails, the impact of this load is spread evenly amongst other computing nodes of the node ID. Moreover, subsequent failures are also spread out evenly. This minimizes the possibility of cascading failure, which may frequently occur in conventional circular hashing techniques.

By way of an example, if plurality of computing nodes 102 include eight nodes, eight node IDs are generated, such that, each of the eight node IDs include a unique pseudo random sequence of the eight computing nodes. This is depicted through table 1 given below:

TABLE 1

| Computing Node | |
|---|---|
| Data Hash Value | |
| (Hash bin) | Node IDs |
| 0 | 6 0 1 5 7 3 2 4 |
| 1 | 2 0 4 3 5 7 1 6 |
| 2 | 0 3 5 2 6 1 4 7 |
| 3 | 1 3 2 0 7 6 5 4 |
| 4 | 0 2 4 5 7 6 1 3 |
| 5 | 5 0 4 7 2 3 1 6 |
| 6 | 0 1 2 4 6 3 5 7 |
| 7 | 2 6 0 3 7 4 1 5 |

In the above table, each computing node is associated with a node ID. It will be apparent to a person skilled in the art that node IDs are associated with a computing node for illustrative purpose only. Actual allocation of a node ID to a particular computing node is explained at step 304. Each of the eight node IDs in the table above has a unique pseudo random sequence of the eight computing nodes (i.e., computing nodes 0 to 7). In each node ID, the first node acts as the primary node for a corresponding computing node (or a hash bin). For example, the computing node 0 is the primary node for hash bins 2, 4, and 6. Based on the associated node IDs, if the computing node 0 fails, then requests to the computing node 2 will be re-routed to the computing node 3, requests to the computing node 4 will be re-routed to the computing node 2, and requests to the computing node 6 will be re-routed to the computing node 1.

At step 304, application server 104, selects a node ID from the plurality of node IDs for data placement of a computing node from plurality of computing nodes 102. The node ID is selected based on a placement score computed for each of the plurality of node IDs. The node ID is selected, as it has the highest placement score when compared to the placement score computed for the remaining plurality of node IDs. The placement score may provide a single number of “fitness” for each node ID in the plurality of node IDs.

The placement score for a node ID is computed based on a data placement criterion associated with the computing node and predefined scoring criteria. The data placement criterion associated with the computing node may include one or more of computation requirements for accessing data, number of users accessing the data, peak time for accessing the data, criticality of data availability, or sensitivity associated with the data. In other words, based on the type of data or application which is to be accessed, the data placement criteria would change for a computing node. As a result, a particular computing node sequence in a node ID may get much higher placement rank for a given type of data or application. While the same node sequence in the node ID may get a much lower placement rank for a different type of data or application. By way of an example, the node ID, which has computing nodes closer to location of users accessing a particular data, may be assigned a higher placement score.

The placement score for a node ID is also computed based on the predefined scoring criterion. The predefined scoring criterion for a node ID may include location of adjacent computing nodes within the node ID. Closely placed adjacent computing in the node ID negatively impact the placement score for the node ID. By way of an example, for a randomly selected data reference (or address), a sequence in a node ID, which places all redundant copies of data or application on the same computing node (or machine) may be penalized compared to a sequence in another node ID, which spreads redundant copies of data or application to computing nodes (or machines) on different racks and/or data centers.

Additionally, the predefined scoring criterion for a node ID may include failure probability of each computing node within the node ID. Failure probability of a computing node may be determined based on historic failure rate and computational resources at disposal of the computing node. Computational resources, for example, may include, but are not limited to processor grade, amount of Random Access Memory (RAM), and type and capacity of storage.

A computing node's failure probability may be expressed as a failure correlation matrix, which may describe likelihood of individual and pairwise failure of computing nodes. The failure correlation matrix may be estimated from industry data, computing node placement in the rack and datacenter, rack power supplies, node power supplies, or datacenter network switches. After system 100 runs for a while, values for the failure correlation matrix may be inferred directly from the site data.

Such selection of node ID for data placement based on the placement score described above minimizes the impact of failure and maximizes read speed (for example, by placing copies in data centers that are close to clients accessing the data). In an embodiment, such selection of node IDs is enabled as there may be 64000 node IDs, which computing nodes may use as an identity for multiple clients. As in practical scenarios, most deployments may have significantly fewer number of computing nodes (i.e., lower than 64000 computing nodes), a suitable set of node IDs (with high probability) may achieve an optimal score” for any type of required data placement.

Once the node ID is selected, the data or application is stored on each computing node associated with the node ID. In other words, a copy or instance of the data or application is stored on each computing node in the node ID. By way of an example, referring back to table 1, for the computing node 1, as the associated node ID is “2 0 4 3 5 7 1 6,” a copy of data may be copied on each of the computing nodes 2, 0, 4, 3, 5, 7, 1, and 6.

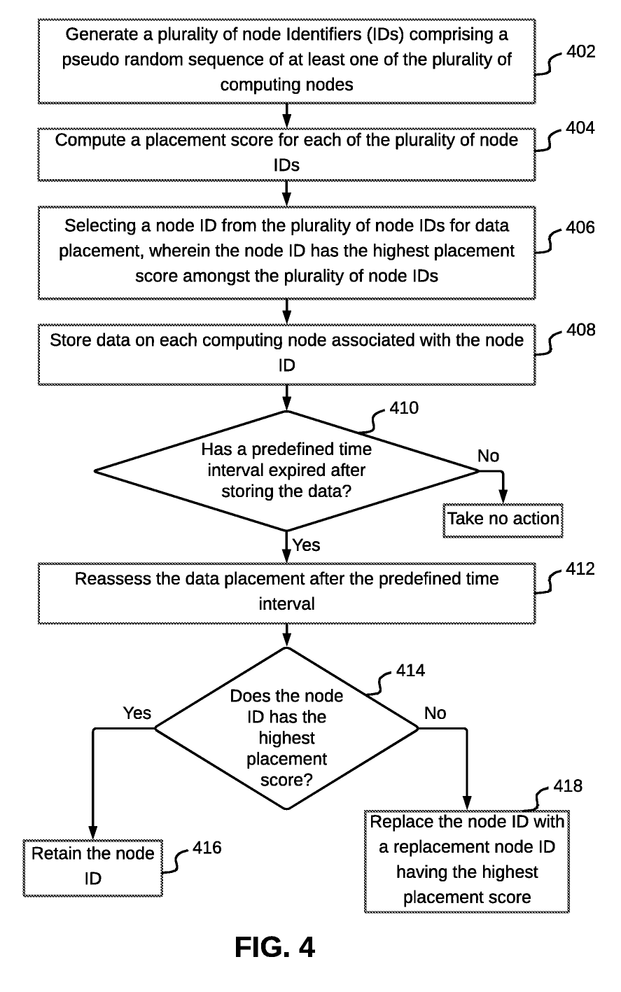

After a predefined time interval, application server 104, at step 306, reassesses the data placement based on the node ID selected at step 302. In order to reassess the node ID, it is determined whether after expiry of the predefined time interval, the node ID still has the highest placement score, when compared with other node IDs in the plurality of node IDs. This is further explained in detail in conjunction with FIG. 4.

The node ID selection for data placement is thus an iterative process that ensures a robust placement of data based on the changing network conditions and user requirements. This iterative process may be carried out once at design time, i.e., before the system is installed. Thereafter, the iterative process may be carried out at various times during operation. Due to the iterative nature of the method, it continuously searched for a better data placement, thereby continuously improving performance for plurality of nodes 102. If node IDs are to be removed or added, the above discussed method may determine the best node IDs to remove or add.

Referring now to FIG. 4, a flowchart of a method of selection of a node ID for data placement and reassessment of the selection of the node ID is illustrated, in accordance with an embodiment. At step 402, a plurality of node IDs associated with plurality of computing nodes 102 are generated. Each of the plurality of node IDs includes a pseudo random sequence of one or more of plurality of computing nodes 102. At step 404, a placement score is computed for each of the plurality of node IDs. The placement score for a node ID is computed based on a data placement criterion associated with the computing node and predefined scoring criteria. At step 406, a node ID from the plurality of node IDs is selected for data placement of a computing node from plurality of computing nodes 102. The node ID is selected based on a placement score computed for each of the plurality of node IDs. The node ID is selected, as it has the highest placement score when compared to the placement score computed for the remaining plurality of node IDs. Thereafter, at step 408, data is stored on each computing node associated with the node ID.

At step 410, a check is performed to determine, whether a predefined time interval has expired after storing the data. If the predefined time interval has not expired, no action is taken. However, if the predefined time interval has expired, the data placement on the node ID is reassessed at step 412. This has already been explained in detail in conjunction with FIG. 3. At step 414, a check is performed to determine whether the node ID still has the highest placement score or not, when compared with placement score for other node IDs in the plurality of node IDs. If the node ID has the highest placement score, the node ID is retained at step 416. However, if the node ID does not have the highest placement score, the node ID is replaced with a replacement node ID that has the highest placement score. Thereafter, data may be stored in computing nodes associated with the replacement node ID. The node ID selection for data placement is thus an iterative process that ensures a robust placement of data based on the changing network conditions and user requirements.

Referring now to FIG. 5, a flowchart of a method of distributed data storage with a failover mechanism is illustrated, in accordance with an embodiment. At step 502, application server 104 generates a plurality of node IDs associated with plurality of computing nodes 102. Each of the plurality of node IDs include a pseudo random sequence of one or more of plurality of computing nodes 102. Based on a placement score computed for each of the plurality of node IDs, application server 104 selects a node ID from the plurality of node IDs for data placement of a computing node at step 504. The node ID has a highest placement score amongst the plurality of node IDs. This has already been explained in detail in conjunction with FIG. 3.

Once the node ID has been selected, application server 104, identifies a failover node from a set of computing nodes associated with the node ID at step 506. The failover node may be selected based on a failover score computed for each of the set of computing nodes. The failover node is used as a backup computing node, when a primary node in the set of computing nodes for the node ID, fails. As a PERMUTE function is used to generate a pseudo random sequence of computing nodes, it allows a client to know what computing nodes to ask for backup data, without external input.

The failover score for a computing node from the set of computing nodes is computed based on location of the computing node relative to a primary node in the set of computing nodes. A computing node that is closely placed to the primary node negatively impacts the failover score for that computing node, as the chances of cascading failure becomes high. The failover score for a computing node from the set of computing nodes may also be computed based on failure probability of each computing node in the set of computing nodes. Failure probability of a computing node is determined based on historic failure rate and computational resources at disposal of the computing node. The methodology used to compute failover score is similar to the predefined scoring criteria used to compute placement score for a computing node. This has already been explained in detail in conjunction with FIG. 3.

Referring now to FIG. 6, a flowchart of a method of selecting a failover node for distributed data storage is illustrated, in accordance with an embodiment. At step 602, a plurality of node IDs associated with plurality of computing nodes 102 are generated. Each of the plurality of node IDs include a pseudo random sequence of one or more of plurality of computing nodes 102. At step 604, a placement score is computed for each of the plurality of node IDs. Based on a placement score computed for each of the plurality of node IDs, a node ID from the plurality of node IDs is selected for data placement of a computing node at step 606. The node ID has a highest placement score amongst the plurality of node IDs. This has already been explained in detail in conjunction with FIG. 3.

Once the node ID has been selected, a failover node is identified from a set of computing nodes associated with the node ID at step 608. The failover node may be selected based on a failover score computed for each of the set of computing nodes. The failover node is used as a backup computing node, when a primary node in the set of computing nodes for the node ID, fails. The computation of failover score for a computing node has been already been explained in detail in conjunction with FIG. 5.

At step 610, a check is performed to determine, whether a predefined time interval has expired after selection of the failover node. If the predefined time interval has not expired, no action is taken. However, if the predefined time interval has expired, identification of the failover node is revaluated by computing a failover score for each of the set of computing nodes again at step 612. At step 614, a check is performed to determine whether the failover node still has the highest failover score or not, when compared with failover score for other computing nodes in the set of computing nodes. If failover node still has the highest failover score, the failover node is retained at step 616. However, if the failover node does not have the highest failover score, the failover node is replaced with a replacement failover node that has the highest failover score. The failover node selection is thus an iterative process that ensures continuous availability of data to clients, irrespective of failure of the primary node.

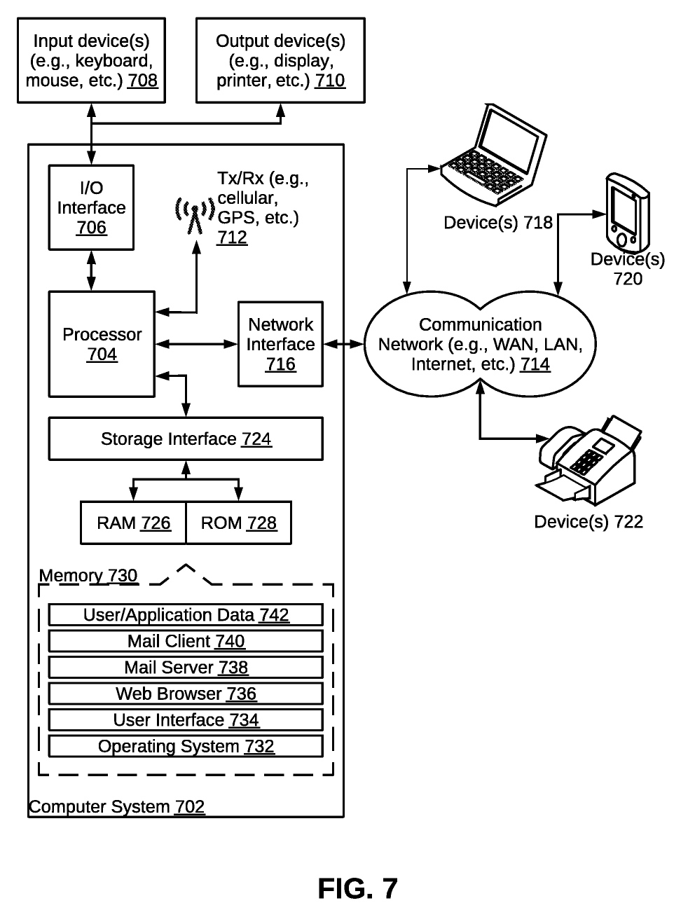

FIG. 7 is a block diagram of an exemplary computer system for implementing various embodiments. Computer system 702 may include a central processing unit (“CPU” or “processor”) 704. Processor 704 may include at least one data processor for executing program components for executing user- or system-generated requests. A user may include a person, a person using a device such as such as those included in this disclosure, or such a device itself. Processor 704 may include specialized processing units such as integrated system (bus) controllers, memory management control units, floating point units, graphics processing units, digital signal processing units, etc. Processor 704 may include a microprocessor, such as AMD® ATHLON® microprocessor, DURON® microprocessor OR OPTERON® microprocessor, ARM's application, embedded or secure processors, IBM® POWERPC®, INTEL'S CORE® processor, ITANIUM® processor, XEON® processor, CELERON® processor or other line of processors, etc. Processor 704 may be implemented using mainframe, distributed processor, multi-core, parallel, grid, or other architectures. Some embodiments may utilize embedded technologies like application-specific integrated circuits (ASICs), digital signal processors (DSPs), Field Programmable Gate Arrays (FPGAs), etc.

Processor 704 may be disposed in communication with one or more input/output (I/O) devices via an I/O interface 706. I/O interface 706 may employ communication protocols/methods such as, without limitation, audio, analog, digital, monoaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.n /b/g/n/x, Bluetooth, cellular (e.g., code-division multiple access (CDMA), high-speed packet access (HSPA+), global system for mobile communications (GSM), long-term evolution (LTE), WiMax, or the like), etc.

Using I/O interface 706, computer system 702 may communicate with one or more I/O devices. For example, an input device 708 may be an antenna, keyboard, mouse, joystick, (infrared) remote control, camera, card reader, fax machine, dongle, biometric reader, microphone, touch screen, touchpad, trackball, sensor (e.g., accelerometer, light sensor, GPS, gyroscope, proximity sensor, or the like), stylus, scanner, storage device, transceiver, video device/source, visors, etc. An output device 710 may be a printer, fax machine, video display (e.g., cathode ray tube (CRT), liquid crystal display (LCD), light-emitting diode (LED), plasma, or the like), audio speaker, etc. In some embodiments, a transceiver 712 may be disposed in connection with processor 704. Transceiver 712 may facilitate various types of wireless transmission or reception. For example, transceiver 712 may include an antenna operatively connected to a transceiver chip (e.g., TEXAS® INSTRUMENTS WILINK WL1283® transceiver, BROADCOM® BCM4550IUB8® transceiver, INFINEON TECHNOLOGIES® X-GOLD 618-PMB9800® transceiver, or the like), providing IEEE 802.6a/b/g/n, Bluetooth, FM, global positioning system (GPS), 2G/3G HSDPA/HSUPA communications, etc.

In some embodiments, processor 704 may be disposed in communication with a communication network 714 via a network interface 716. Network interface 716 may communicate with communication network 714. Network interface 716 may employ connection protocols including, without limitation, direct connect, Ethernet (e.g., twisted pair 50/500/5000 Base T), transmission control protocol/internet protocol (TCP/IP), token ring, IEEE 802.11a/b/g/n/x, etc. Communication network 714 may include, without limitation, a direct interconnection, local area network (LAN), wide area network (WAN), wireless network (e.g., using Wireless Application Protocol), the Internet, etc. Using network interface 716 and communication network 714, computer system 702 may communicate with devices 718, 720, and 722. These devices may include, without limitation, personal computer(s), server(s), fax machines, printers, scanners, various mobile devices such as cellular telephones, smartphones (e.g., APPLE® IPHONE® smartphone, BLACKBERRY® smartphone, ANDROID® based phones, etc.), tablet computers, eBook readers (AMAZON® KINDLE® ereader, NOOK® tablet computer, etc.), laptop computers, notebooks, gaming consoles (MICROSOFT® XBOX® gaming console, NINTENDO® DS® gaming console, SONY® PLAYSTATION® gaming console, etc.), or the like. In some embodiments, computer system 702 may itself embody one or more of these devices.

In some embodiments, processor 704 may be disposed in communication with one or more memory devices (e.g., RAM 726, ROM 728, etc.) via a storage interface 724. Storage interface 724 may connect to memory 730 including, without limitation, memory drives, removable disc drives, etc., employing connection protocols such as serial advanced technology attachment (SATA), integrated drive electronics (IDE), IEEE-1394, universal serial bus (USB), fiber channel, small computer systems interface (SCSI), etc. The memory drives may further include a drum, magnetic disc drive, magneto-optical drive, optical drive, redundant array of independent discs (RAID), solid-state memory devices, solid-state drives, etc.

Memory 730 may store a collection of program or database components, including, without limitation, an operating system 732, user interface application 734, web browser 736, mail server 738, mail client 740, user/application data 742 (e.g., any data variables or data records discussed in this disclosure), etc. Operating system 732 may facilitate resource management and operation of computer system 702. Examples of operating systems 732 include, without limitation, APPLE® MACINTOSH® OS X platform, UNIX platform, Unix-like system distributions (e.g., Berkeley Software Distribution (BSD), FreeBSD, NetBSD, OpenBSD, etc.), LINUX distributions (e.g., RED HAT®, UBUNTU®, KUBUNTU®, etc.), IBM® OS/2 platform, MICROSOFT® WINDOWS® platform (XP, Vista/7/8, etc.), APPLE® IOS® platform, GOOGLE® ANDROID® platform, BLACKBERRY® OS platform, or the like. User interface 734 may facilitate display, execution, interaction, manipulation, or operation of program components through textual or graphical facilities. For example, user interfaces may provide computer interaction interface elements on a display system operatively connected to computer system 702, such as cursors, icons, check boxes, menus, scrollers, windows, widgets, etc. Graphical user interfaces (GUIs) may be employed, including, without limitation, APPLE® Macintosh® operating systems' AQUA® platform, IBM® OS/2® platform, MICROSOFT® WINDOWS® platform (e.g., AERO® platform, METRO® platform, etc.), UNIX X-WINDOWS, web interface libraries (e.g., ACTIVEX® platform, JAVA® programming language, JAVASCRIPT® programming language, AJAX® programming language, HTML, ADOBE® FLASH® platform, etc.), or the like.

In some embodiments, computer system 702 may implement a web browser 736 stored program component. Web browser 736 may be a hypertext viewing application, such as MICROSOFT® INTERNET EXPLORER® web browser, GOOGLE® CHROME® web browser, MOZILLA® FIREFOX® web browser, APPLE® SAFARI® web browser, etc. Secure web browsing may be provided using HTTPS (secure hypertext transport protocol), secure sockets layer (SSL), Transport Layer Security (TLS), etc. Web browsers may utilize facilities such as AJAX, DHTML, ADOBE® FLASH® platform, JAVASCRIPT® programming language, JAVA® programming language, application programming interfaces (APis), etc. In some embodiments, computer system 702 may implement a mail server 738 stored program component. Mail server 738 may be an Internet mail server such as MICROSOFT® EXCHANGE® mail server, or the like. Mail server 738 may utilize facilities such as ASP, ActiveX, ANSI C++/C#, MICROSOFT .NET® programming language, CGI scripts, JAVA® programming language, JAVASCRIPT® programming language, PERL® programming language, PHP® programming language, PYTHON® programming language, WebObjects, etc. Mail server 738 may utilize communication protocols such as internet message access protocol (IMAP), messaging application programming interface (MAPI), Microsoft Exchange, post office protocol (POP), simple mail transfer protocol (SMTP), or the like. In some embodiments, computer system 702 may implement a mail client 740 stored program component. Mail client 740 may be a mail viewing application, such as APPLE MAIL® mail client, MICROSOFT ENTOURAGE® mail client, MICROSOFT OUTLOOK® mail client, MOZILLA THUNDERBIRD® mail client, etc.

In some embodiments, computer system 702 may store user/application data 742, such as the data, variables, records, etc. as described in this disclosure. Such databases may be implemented as fault-tolerant, relational, scalable, secure databases such as ORACLE® database OR SYBASE® database. Alternatively, such databases may be implemented using standardized data structures, such as an array, hash, linked list, struct, structured text file (e.g., XML), table, or as object-oriented databases (e.g., using OBJECTSTORE® object database, POET® object database, ZOPE® object database, etc.). Such databases may be consolidated or distributed, sometimes among the various computer systems discussed above in this disclosure. It is to be understood that the structure and operation of the any computer or database component may be combined, consolidated, or distributed in any working combination.

It will be appreciated that, for clarity purposes, the above description has described embodiments of the invention with reference to different functional units and processors. However, it will be apparent that any suitable distribution of functionality between different functional units, processors or domains may be used without detracting from the invention. For example, functionality illustrated to be performed by separate processors or controllers may be performed by the same processor or controller. Hence, references to specific functional units are only to be seen as references to suitable means for providing the described functionality, rather than indicative of a strict logical or physical structure or organization.

Various embodiments of the invention provide method and device for improved distributed data storage amongst multiple computing nodes. The method limits the hash to 64 bits (which is a standard long integer). This is much more convenient to work with programmatically and is a lot faster to pass around the system too, as hardware these days are mostly optimized for 64 bit values. The method further uses a random permutation function of node IDs to set the sequence of storage nodes based on content hash. In this way, all 64K bins have a completely separate (pseudo random) sequence of nodes onto which their redundant data is stored. As a result, the method faces no cascading failure issues. On the client side, a series of node IDs that might hold the required data is constructed in a pseudo-random series, but not sequential from any starting position. Thus, data storage is secure, as the position of the storage of data cannot be derived by any hacker.

The improved circular hashing technique of the method prevents cascading failure, while accessing or storing data at multiple node points. The improved circular hashing technique also enables storage nodes to be coded into “positions” in a way that represents the optimal placement, with reference to failure tolerance, access speed, and other design requirements.

The specification has described method and device for improved distributed data storage amongst multiple computing nodes. The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

What is claimed is:

1. A method of distributed data storage amongst a plurality of computing nodes, the method comprising:
generating, by an application server, a plurality of node Identifiers (IDs) comprising a pseudo random sequence of at least one of the plurality of computing nodes, wherein the plurality of node IDs is associated with the plurality of computing nodes;
selecting, by the application server, a node ID from the plurality of node IDs for data placement of a computing node, based on a placement score computed for each of the plurality of node IDs, wherein the node ID comprises a highest placement score amongst the plurality of node IDs;
reassessing, by the application server, the data placement after a predefined time interval, wherein reassessing comprises determining whether the node ID comprises the highest placement score after expiry of the predefined time interval.

2. The method of claim 1 further comprising:
replacing the node ID with a replacement node ID comprising a highest placement score amongst the plurality of node IDs, when the node ID does not have the highest placement score after expiry of the predefined time interval.

3. The method of claim 1 further comprising:
retaining the node ID, when the node ID comprises a highest placement score amongst the plurality of node IDs after expiry of the predefined time interval.

4. The method of claim 1, further comprising storing data on each computing node associated with the node ID.

5. The method of claim 1, wherein the placement score for each of the plurality of node IDs is computed based on a data placement criterion associated with the computing node and predefined scoring criteria.

6. The method of claim 5, wherein the predefined scoring criterion for a node ID in the plurality of node IDs comprises at least one of:
location of adjacent computing nodes within the node ID, wherein closely placed adjacent computing nodes negatively impact the score for the node ID; and
failure probability of each computing node within the node ID, wherein failure probability of a computing node is determined based on historic failure rate and computational resources at disposal of the computing node.

7. The method of claim 5, wherein the data placement criterion for the computing node comprises at least one of computation requirements for accessing data, number of users accessing the data, peak time for accessing data, criticality of data availability, or sensitivity associated with the data.

8. The method of claim 1, wherein pseudo random sequence for each of the plurality of node IDs is unique, and wherein the pseudo random sequence is generated by applying a pseudo random permutation function.

9. A method of distributed data storage with a failover mechanism, the method comprising:
generating, by an application server, a plurality of node Identifiers (IDs) comprising a pseudo random sequence of at least one of a plurality of computing nodes, wherein the plurality of node IDs is associated with the plurality of computing nodes;
selecting, by the application server, a node ID from the plurality of node IDs for data placement of a computing node, based on a placement score computed for each of the plurality of node IDs, wherein the node ID comprises a highest placement score amongst the plurality of node IDs; and
identifying, by the application server, a failover node from a set of computing nodes associated with the node ID, based on a failover score computed for each of the set of computing nodes.

10. The method of claim 9, wherein the failover score for a computing node from the set of computing nodes is computed based on at least one of:
location of the computing node relative to a primary node in the set of computing nodes, wherein closely placed computing node negatively impact the failover score for the computing node; and
failure probability of each computing node in the set of computing nodes, wherein failure probability of a computing node is determined based on historic failure rate and computational resources at disposal of the computing node.

11. The method of claim 9, wherein the failover node is used as a backup computing node, when a primary node in the node ID fails.

12. The method of claim 9, further comprising:
revaluating identification of the failover node, wherein revaluating comprises computing a failover score for each of the set of computing nodes after expiry of a predefined time interval; and
replacing the failover node with a replacement failover node, wherein the replacement failover node comprises a highest failover score amongst the set of computing nodes.

13. An application server enabling distributed data storage amongst a plurality of computing nodes, the application server comprising:
a processor; and
a memory communicatively coupled to the processor, wherein the memory stores processor instructions, which, on execution, causes the processor to:
generate a plurality of node Identifiers (IDs) comprising a pseudo random sequence of at least one of the plurality of computing nodes, wherein the plurality of node IDs is associated with the plurality of computing nodes;
select a node ID from the plurality of node IDs for data placement of a computing node, based on a placement score computed for each of the plurality of node IDs, wherein the node ID comprises a highest placement score amongst the plurality of node IDs;
reassess the data placement after a predefined time interval, wherein reassessing comprises determining whether the node ID comprises the highest placement score after expiry of the predefined time interval.

14. The application server of claim 13, wherein the processor instructions further cause the processor to replace the node ID with a replacement node ID comprising a highest placement score amongst the plurality of node IDs, when the node ID does not have the highest placement score after expiry of the predefined time interval.

15. The application server of claim 13, wherein the processor instructions further cause the processor to retain the node ID, when the node ID comprises a highest placement score amongst the plurality of node IDs after expiry of the predefined time interval.

16. The application server of claim 13, wherein the processor instructions further cause the processor to store data on each computing node associated with the node ID.

17. The application server of claim 13, wherein pseudo random sequence for each of the plurality of node IDs is unique, and wherein the pseudo random sequence is generated by applying a pseudo random permutation function.

18. An application server enabling distributed data storage with a failover mechanism, the application server comprising:
a processor; and
a memory communicatively coupled to the processor, wherein the memory stores processor instructions, which, on execution, causes the processor to:
generate a plurality of node Identifiers (IDs) comprising a pseudo random sequence of at least one of a plurality of computing nodes, wherein the plurality of node IDs is associated with the plurality of computing nodes;
select a node ID from the plurality of node IDs for data placement of a computing node, based on a placement score computed for each of the plurality of node IDs, wherein the node ID comprises a highest placement score amongst the plurality of node IDs; and
identify a failover node from a set of computing nodes associated with the node ID, based on a failover score computed for each of the set of computing nodes.

19. The application server of claim 18, wherein the failover node is used as a backup computing node, when a primary node in the node ID fails.

20. The application server of claim 18, wherein the processor instructions further cause the processor to:
revaluate identification of the failover node, wherein revaluating comprises computing a failover score for each of the set of computing nodes after expiry of a predefined time interval; and
replace the failover node with a replacement failover node, wherein the replacement failover node comprises a highest failover score amongst the set of computing nodes.
